(19) United States
(12) Patent Application Publication
(10) Pub. No.: US 2026/0178947 A1
(43) Pub. Date: Jun. 25, 2026

(54) BINARY REASONING PROMPT SYSTEM

(71) Applicant: Foundation of Soongsil University-Industry Cooperation, Seoul (KR)

(72) Inventors: Daeseon Choi, Daejeon (KR); Sungjune Park, Hanam-si (KR)

(21) Appl. No.: 19/421,445

(22) Filed: Dec. 16, 2025

(30) Foreign Application Priority Data
Dec. 20, 2024 (KR) 10-2024-0192504

(51) Int. Cl. G06N 5/045

(52) U.S. Cl. CPC G06N 5/045

(57) ABSTRACT

A binary reasoning prompt system according to one embodiment of the disclosed disclosure may include an input module configured to receive verification-target data, which is subject to verification to determine whether the content of verification-target data is true or false, and a truth/false determination module configured to determine whether the verification-target data is true or false, using a generative AI model, on the basis of a truth determination rationale on which basis the verification-target data is determined to be true and a false determination rationale on which basis the verification-target data is determined to be false.

### CROSS REFERENCE TO RELATED APPLICATION

This application claims the benefit of Korean Patent Application No. 10-2024-0192504, filed on Dec. 20, 2024, in the Korean Intellectual Property Office, the disclosure of which is incorporated herein in its entirety by reference.

### TECHNICAL FIELD

The present disclosure relates to a binary reasoning prompt system capable of determining whether the content of verification-target data is true or false.

### BACKGROUND ART

A generative AI model is a model that understands sentences using natural language processing (NLP) technology and generates appropriate responses corresponding thereto. The generative AI model is on the basis of learning a large amount of text data to understand context and identify patterns and rules.

The AI model is used to understand words, phrases, and context within sentences and generate new sentences. In this process, the generative AI model generates expected responses on the basis of learned data and experience.

Recently, large language models (LLMs) have demonstrated outstanding performance across a variety of tasks. Prompt engineering has been applied to maximize the performance of such large language models.

The present disclosure was derived from research conducted as part of the Ministry of Science and ICT's Information Security Core Source Technology Development (R&D) (Project Identification Number: 2710008252, Project Number: 00398353, Research Project Title: Development of Generative AI Security Threat Response Technology, Project Management Agency: Information and Communications Technology Planning and Evaluation Institute, Project Execution Agency: Soongsil University Industry-Academic Cooperation Foundation, Research Period: Apr. 1, 2024 to December 31, 2024). In this regard, the Korean government has no property interest in every aspect of the present disclosure.

### SUMMARY

### Technical Problem

The present disclosure is directed to providing a binary reasoning prompt system

capable of accurately determining truth or false of the content of verification-target data and a method of controlling the binary reasoning prompt system.

In addition, the present disclosure is directed to providing a binary reasoning prompt system capable of detecting fake news and a method of controlling the binary reasoning prompt system.

In addition, the present disclosure is directed to providing a binary reasoning prompt system that has strong potential in practical applications such as spam filtering and social media content analysis and a method of controlling the binary reasoning prompt system.

In addition, the present disclosure is directed to providing a binary reasoning prompt system that may also be applied to specialized fields such as medical record analysis and a method of controlling the binary reasoning prompt system.

In addition, the present disclosure is directed to providing a binary reasoning prompt system that may improve performance, such as increasing data processing speed or reducing required memory capacity compared to conventional systems and a method of controlling the binary reasoning prompt system.

### Solution To Problem

A binary reasoning prompt system according to an aspect of the present disclosure

may include: an input module configured to receive verification-target data to be verified as to whether the content of data is true or false; and a truth/false determination module configured to determine whether the verification-target data is true or false using a generative AI model on the basis of a truth determination rationale presenting the rationale for determining that the verification-target data is to be true and a false determination rationale presenting the rationale for determining that the verification-target data is to be false.

In addition, the generative AI model may include a lawyer-role generative AI model configured to determine input verification-target data to be true and to output truth-determination rationale data for the verification-target data; a prosecutor-role generative AI model configured to determine the input verification-target data to be false and to output false-determination rationale data for the verification-target data; and a judge-role generative AI model configured to determine whether the verification-target data is true or false on the basis of the truth-determination rationale data and the false-determination rationale data.

In addition, the truth/false determination module may be configured to input the verification-target data into the lawyer-role generative AI model and the prosecutor-role generative AI model; input the truth-determination rationale data output by the lawyer-role generative AI model and the false-determination rationale data output by the prosecutor-role generative AI model into the judge-role generative AI model; and determine whether the verification-target data is true or false using the judge-role generative AI model on the basis of the truth-determination rationale data and the false-determination rationale data.

In addition, the lawyer-role generative AI model, the prosecutor-role generative AI model, and the judge-role generative AI model may be generative AI models trained by a machine learning method in which machine learning is repeatedly performed by setting learning verification-target data indicating whether each content is preset as true or false as input variables and setting information indicating whether the learning verification-target data is preset as true or false as output variables; and the judge-role generative AI model is a generative AI model trained by the machine learning method in which repetitive machine learning is performed more times than a number of times of repetitive machine learning performed by the lawyer-role generative AI model and a number of times of repetitive machine learning performed by the prosecutor-role generative AI model.

In addition, the truth/false determination module may perform a plurality of times, a judgment process in which the lawyer-role generative AI model generates the truth-determination rationale data, the prosecutor-role generative AI model generates the false-determination rationale data, and the judge-role generative AI model determines whether the verification-target data is true or false on the basis of the truth-determination rationale data and the false-determination rationale data.

In addition, the truth/false determination module may determine the verification-target data to be true when the judgment processes determined as true occur more frequently among the judgment processes determined as true and the judgment processes determined as false, and may determine the verification-target data to be false when the judgment processes determined as false occur more frequently among the judgment processes determined as true and the judgment processes determined as false.

In addition, for each judgment process, the judge-role generative AI model may be configured to output the truth judgment rationale presenting the rationale on which the verification-target data is determined to be true as a judgment rationale when the verification-target data is determined to be true, and to output the false judgment rationale presenting the rationale on which the verification-target data is determined to be false as the judgment rationale when the verification-target data is determined to be false.

In addition, the truth/false determination module may be configured to: determine whether the verification-target data is true or false using the judge-role generative AI model and generate the judgment rationale in a first judgment process which is one of a plurality of judgment processes; input the judgment rationale output by the judge-role generative AI model into the lawyer-role generative AI model and the prosecutor-role generative AI model in a second judgment process which is a subsequent judgment process following the first judgment process; determine the verification-target data to be true using the lawyer-role generative AI model, on the basis of the verification-target data and the judgment rationale and output truth-determination rationale data including the determination details for the judgment rationale in the second judgment process; determine the verification-target data to be false using the prosecutor-role generative AI model, on the basis of the verification-target data and the judgment rationale and output false-determination rationale data including the determination details for the judgment rationale in the second judgment process; and determine whether the verification-target data is true or false using the judge-role generative AI model, on the basis of the truth-determination rationale data including the determination details for the judgment rationale and the false-determination rationale data including the determination details for the judgment rationale in the second judgment process.

A method of controlling a binary reasoning prompt system according to an aspect of the present disclosure may include receiving, by an input module, verification-target data to be verified as to whether the content of data is true or false, and determining, by a truth/false determination module, whether the verification-target data is true or false using a generative AI model, on the basis of a truth determination rationale presenting the rationale for determining that the verification-target data is to be true and a false determination rationale presenting the rationale for determining that the verification-target data is to be false, wherein the generative AI model may include: a lawyer-role generative AI model configured to determine input verification-target data to be true and to output truth-determination rationale data for the verification-target data; a prosecutor-role generative AI model configured to determine the input verification-target data to be false and to output false-determination rationale data for the verification-target data; and a judge-role generative AI model configured to determine whether the verification-target data is true or false, on the basis of the truth-determination rationale data and the false-determination rationale data, wherein the determining whether the verification-target data is true or false may include: inputting, by the truth/false determination module, the verification-target data into the lawyer-role generative AI model and the prosecutor-role generative AI model; inputting, by the truth/false determination module, the truth-determination rationale data output by the lawyer-role generative AI model and the false-determination rationale data output by the prosecutor-role generative AI model into the judge-role generative AI model; and determining, by the truth/false determination module, whether the verification-target data is true or false using the judge-role generative AI model, on the basis of the truth-determination rationale data and the false-determination rationale data.

A computer program according to an aspect of the present disclosure may be stored in a non-transitory computer-readable recording medium to execute the method of controlling the binary reasoning prompt system.

### Effect Of Invention

According to one aspect of the present disclosure, it is possible to accurately determine whether the content of verification-target data is true or false.

According to one embodiment of the present disclosure, it is possible to detect fake news.

According to one embodiment of the present disclosure, it is possible to have powerful potential for practical applications such as spam filtering and social media content analysis.

According to one embodiment of the present disclosure, it can also be applied to specialized fields such as medical record analysis.

According to one embodiment of the present disclosure, performance may be improved by increasing data processing speed or reducing required memory capacity, compared with conventional systems.

### BRIEF DESCRIPTION OF DRAWINGS

FIG. 1 is a control block diagram of a binary reasoning prompt system according to one embodiment of the present disclosure.

FIG. 2 is a view for describing an embodiment in which a binary reasoning prompt system is provided on a server.

FIG. 3 is a diagram for describing an operation of each generative AI model according to one embodiment of the present disclosure.

FIG. 4 is a flowchart of a method of controlling a binary reasoning prompt system according to one embodiment of the present disclosure.

FIG. 5 is a table showing experimental results that verifies the performance of truth/false determination of a binary reasoning prompt system according to one embodiment of the present disclosure.

FIG. 6 is a table showing the experimental results that verifies the performance of the binary reasoning prompt system on specific truth/false problems.

FIG. 7 is a table showing the experimental results that verifies the performance of the binary reasoning prompt system on spam SMS and fake news.

### DETAILED DESCRIPTION OF EXEMPLARY EMBODIMENTS

Same reference numerals refer to same components throughout the specification. This specification does not describe all elements of the embodiments, and contents that are general in the technical field to which the disclosed invention belongs or that overlap between the embodiments are omitted.

In addition, when a part is said to “include” a component, this does not mean that it excludes other components, but rather that it may include other components, unless otherwise specifically described.

As used herein, the term “module” and “unit” refers to a unit that processes at least one function or operation and may refer to, for example, software, a field-programmable gate array (FPGA), or a hardware component. The functions provided in the “module” and “unit” may be performed separately by a plurality of components or may be integrated with other additional components. The “module” and “unit” in this specification is not necessarily limited to software or hardware, and may be configured to reside on an addressable storage medium, and may be configured to boot one or more processors. According to embodiments, it is possible for a plurality of “modules” and “units” to be implemented as a single component or it is possible for one “unit” to include a plurality of components.

The terms “first”, “second”, etc. are used to distinguish one component from another, and the components are not limited by the aforementioned terms.

Singular expressions include plural expressions unless the context clearly indicate otherwise.

Reference numerals used for method steps are just used for convenience of explanation, but not to limit an order of the steps. Thus, unless the context clearly dictates otherwise, the written order may be practiced otherwise.

Hereinafter, operation principles and embodiments of the present disclosure are described in more detail in reference to the accompanying drawings.

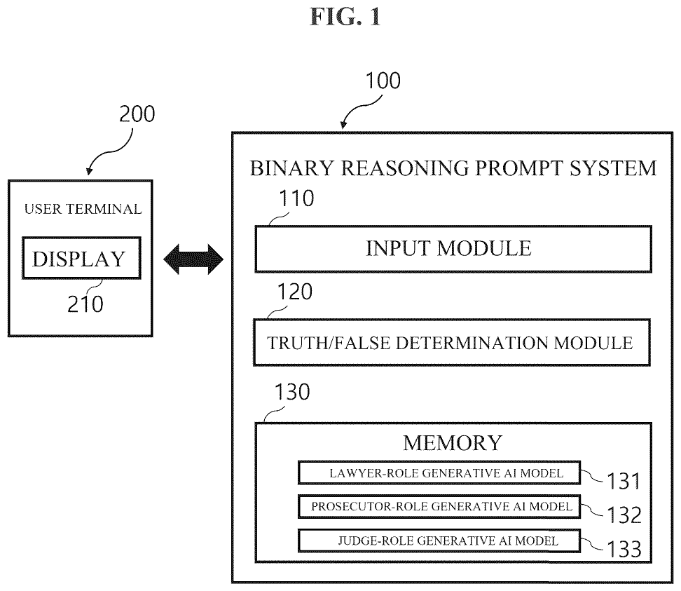

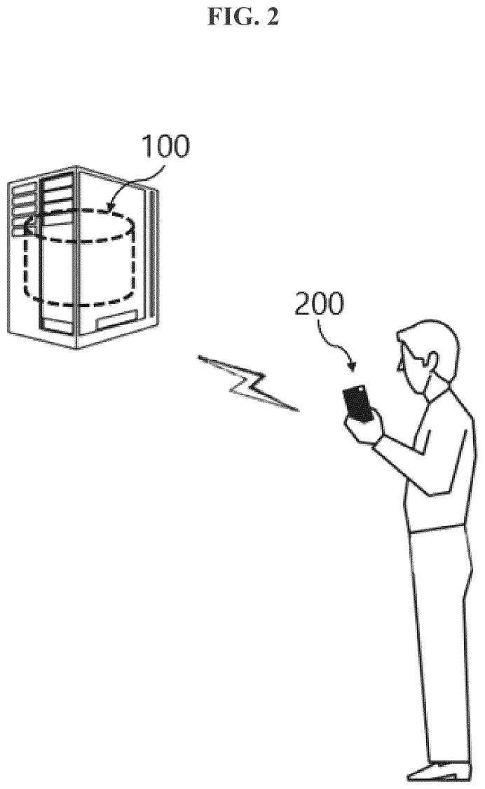

FIG. 1 is a control block diagram of a binary reasoning prompt system according to one embodiment of the present disclosure, and FIG. 2 is a view for describing an embodiment in which a binary reasoning prompt system is provided on a server.

The binary reasoning prompt system 100 may be a system used by a user who intends to determine whether the content of verification-target data is genuine or fake.

The verification-target data may be data subject to verification as to whether the content thereof is true or false.

The verification-target data may include news, articles, photographs, images, videos, SNS (Social Network System) posts, informational articles, and the like, and may be data posted on the Internet, but is not limited thereto.

Referring to FIGS. 1 and 2, the binary reasoning prompt system 100 is provided on a central server and may communicate with at least one user terminal 200 via wired or wireless communication.

The user terminal 200 may be a terminal through which a user inputs input information and checks a screen displayed on a display 210. The user terminal 200 may download and install an application according to the user's option and display information on a recommended application determined by the binary reasoning prompt system 100. The user terminal 200 may be a terminal such as a PC or a smartphone, but it is not limited to any particular device or apparatus, and any terminal used by the user may serve as the user terminal 200.

The user may check a determination result on the truth or falsity of the verification-target data generated by the binary reasoning prompt system 100 or the rationale thereof, through the display 210 of the user terminal 200.

The binary reasoning prompt system 100 may include an input module 110, a truth/false determination module 120, and a memory 130.

The input module 110 may receive the verification-target data by inputting or receiving the verification-target data.

When the binary reasoning prompt system 100 is provided on a server, the input module 110 may be a communication module that receives information entered through an input unit of the user terminal 200, such as a touchpad, or data stored in the user terminal 200, from the user terminal 200.

When the binary reasoning prompt system 100 is provided on the user terminal 200, the input module 110 may receive information entered through the input unit of the user terminal 200 from the input unit of the user terminal 200. That is, a manner in which the input module 110 receives data is not particularly limited.

Meanwhile, reception of the verification-target data by the input module 110 is not necessarily limited to reception from the user terminal 200. For example, when the binary reasoning prompt system 100 is provided on the server, the input module 110 may also receive the verification-target data from a database of the server.

The input module 110 may transmit the received data to the truth/false determination module 120.

The truth/false determination module 120 may determine whether the verification-target data is true or false by using a generative AI model.

The truth/false determination module 120 may determine whether the verification-target data is true or false by using a generative AI model, on the basis of the truth determination rationale and the false determination rationale.

The truth determination rationale may be a rationale on which the verification-target data is determined to be true.

The false determination rationale may be a rationale on which the verification-target data is determined to be false.

The generative AI model may be pre-trained by a machine learning method and stored in the memory 130.

Machine learning may refer to optimizing parameters learning may refer to optimizing parameters of a model composed of a large number of parameters using given data. Machine learning may include supervised learning, unsupervised learning, and reinforcement learning, depending on a form of a learning problem. Supervised learning refers to learning a mapping between inputs and outputs and may be applied when input-output pairs are provided as data. Unsupervised learning is applied when there are only inputs and no outputs, and may identify regularities between inputs.

A machine learning unit including a processor provided in a terminal or a server may generate an AI model in various ways. For example, the machine learning unit may learn features extracted from learning data by using a deep-learning-based learning method. In this case, a convolutional neural network (CNN) structure having multiple convolutional layers stacked thereon, may be utilized to learn a method of extracting features from the training data. However, the learning method of the machine learning unit is not necessarily limited to a method using a CNN structure. For example, the learning method of the machine learning unit may be a machine learning algorithm such as an artificial neural network (ANN) or a recurrent neural network (RNN).

A generative AI model trained through a deep-learning-based learning method may be a deep-learning model used to generate and predict new content from input data. Generative AI models may use deep learning and machine learning algorithms to generate various types of data, such as text, images, and audio. For example, a generative language model may understand context of a given sentence or word and generate a natural sentence base thereon.

Training of generating AI models may be progressed through data collection and model training. In the data collection stage, various types of data may be collected. The data may be in various forms such as text, images, and audio, and may be used to enable the model to perform a specific task. The collected data may ensure diversity in various elements such as subjects, languages, and writing styles, allowing the model to flexibly respond to various situations. In the model training stage, data may be used to train the model. In this case, the model may learn patterns on the basis of the given data and identify relationships between input data and a desired output. Such training may be performed through large-scale computing resources and numerous iterative processes, allowing the model to find optimal parameters and be adjusted to generate appropriate outputs for the given inputs.

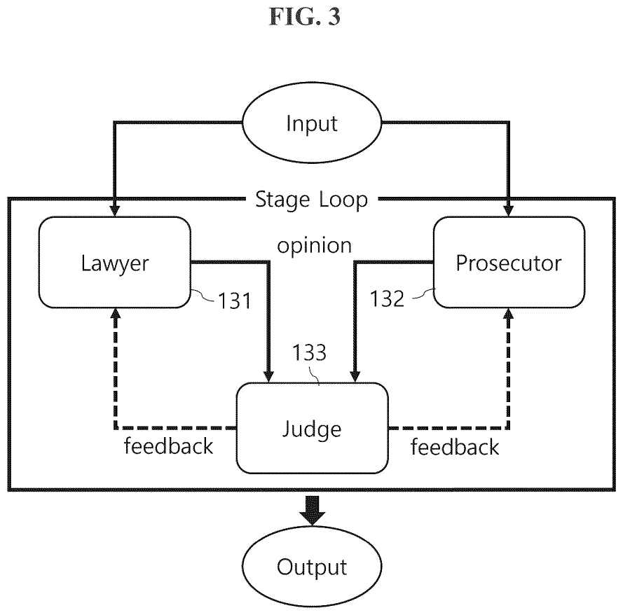

FIG. 3 is a diagram for describing an operation of each generative AI model according to one embodiment of the present disclosure.

Referring to FIGS. 1 and 3, the generative AI models of the binary reasoning prompt system 100 may include a lawyer-role generative AI model 131 lawyer, a prosecutor-role generative AI model 132, and a judge-role generative AI model 133.

The lawyer-role generative AI model 131 may be a generative AI model that explains reasons why the input data (input) is true (normal).

The prosecutor-role generative AI model 132 may be a generative AI model that explains reasons why the input data (input) is false (anomaly).

The binary reasoning prompt system 100 may eliminate a tendency to follow the initially determined opinion through these two generative AI models.

The lawyer-role generative AI model 131 may determine that the input verification-target data is true and output truth-determination rationale data for the verification-target data.

That is, the lawyer-role generative AI model 131 may generate data presenting rationales on which the corresponding verification-target data is assumed to be true, regardless of whether the verification-target data is actually true or false.

The prosecutor-role generative AI model 132 may determine that the input verification-target data is false and output false-determination rationale data for the verification-target data.

That is, the prosecutor-role generative AI model 132 may generate data presenting rationales on which the corresponding verification-target data is assumed to be false, regardless of whether the verification-target data is actually true or false.

The judge-role generative AI model 133 may determine whether the verification-target data is true or false on the basis of the truth-determination rationale data and the false-determination rationale data.

The truth/false determination module 120 may input the verification-target data into the lawyer-role generative AI model 131 and the prosecutor-role generative AI model 132.

The truth/false determination module 120 may input the truth-determination rationale data output by the lawyer-role generative AI model 131 into the judge-role generative AI model 133.

The truth/false determination module 120 may input the false-determination rationale data output by the prosecutor-role generative AI model 132 into the judge-role generative AI model 133.

The truth/false determination module 120 may use the judge-role generative AI model 133 to determine whether the verification-target data is true or false, on the basis of the truth-determination rationale data and the false-determination rationale data.

The lawyer-role generative AI model 131, the prosecutor-role generative AI model 132, and the judge-role generative AI model 133 may be generative AI models trained by a machine learning method in which machine learning is repeatedly performed by setting learning verification-target data indicating whether each content is preset as true or false as input variables and setting information indicating where whether the learning verification-target data is preset as true or false as output variables.

That is, the machine learning unit may generative or train the generative AI models by a machine learning method in which is repeatedly performed by setting the learning verification-target data indicating whether each content is preset as true or false as input variables, and setting the information indicating whether the learning verification-target data is preset as true or false as output variables.

Meanwhile, the lawyer-role generative AI model 131 and the prosecutor-role generative AI model 132 determines first a conclusion as true or false, respectively, performs an analysis on the verification-target data, and output the rationale thereof. Accordingly, a fact that the lawyer-role generative AI model 131 and the prosecutor-role generative AI model 132 are generative AI models whose performance is lower than that of the judge-role generative AI model 133 may be more effective for determination performance of the binary reasoning prompt system 100.

The judge-role generative AI model 133 may perform repetitive machine learning more times than a number of times of repetitive machine learning performed by the lawyer-role generative AI model 131 and a number of times of repetitive machine learning performed by the prosecutor-role generative AI model 132.

For example, when the number of times of repetitive machine learning performed by the lawyer-role generative AI model 131 and the number of times of repetitive machine learning performed by the prosecutor-role generative AI model 132 is 1,000, the number of times of repetitive machine learning performed by the judge-role generative AI model 133 may be 10,000.

Meanwhile, the truth/false the truth/false determination module 120 may perform a plurality of truth/false determinations for a single verification-target data and make a final truth/false determination in a manner similar to a majority vote.

The truth/false determination module 120 may perform the judgment process a plurality of times.

A single judgment process may be a cycle in which the lawyer-role generative AI model 131 generates truth-determination rationale data, the prosecutor-role generative AI model 132 generates false-determination rationale data, and the judge-role generative AI model 133 determines whether the verification-target data is true or false on the basis of the truth-determination rationale data and the false-determination rationale data.

The truth/false determination module 120 may determine the verification-target data to be true when the judgment processes determined as true occur more frequently among the judgment processes determined as true and the judgment processes determined as false.

The truth/false determination module 120 may determine the verification-target data to be false when the judgment processes determined as false occur more frequently among the judgment processes determined as true and the judgment processes determined as false.

For example, when among three judgment processes, one judgment process is determined as true and two judgment processes are determined as false, the truth/false determination module 120 may determine the verification-target data to be false.

Meanwhile, similar to an actual judicial system having a first trial, an appellate trial, and a supreme-court trial, the truth/false determination module 120 may perform multiple truth/false determinations for a single verification-target data. In this case, in each judgment process, each generative AI model may use rationales generated or output in the previous judgment process.

For each judgment process, when the judge-role generative AI model 133 determines the verification-target data to be true, the truth judgment rationale presenting the rationale on which the verification-target data is determined to be true, may be output as a judgment rationale.

For each judgment process, when the judge-role generative AI model 133 determines the verification-target data to be false, the false judgment rationale presenting the rationale on which the verification-target data is determined to be false, may be output as the judgment rationale.

The first judgment process may be any one of a plurality of judgment processes performed by the truth/false determination module 120. The first judgment process may be the earliest judgment process, but is not limited thereto.

The second judgment process may be a judgment process following the any first judgment process. The second judgment process may also be the final judgment process, but is not limited thereto.

Meanwhile, any first judgment process may be the second judgment process with respect to the judgment process immediately preceding it. Furthermore, any second judgment process may be the first judgment process with respect to the judgment process immediately following it.

In the first judgment process, the truth/false determination module 120 may use the judge-role generative AI model 133 to determine whether the verification-target data is true or false and generate a determination rationale.

In the second judgment process, the truth/false determination module 120 may input the judgment rationale output by the judge-role generative AI model 133 into the lawyer-role generative AI model 131 and the prosecutor-role generative AI model 132.

In the second judgment process, the truth/false determination module 120 may use the lawyer-role generative AI model 131 to determine the verification-target data to be true, on the basis of the verification-target data and the judgment rationale, and output truth-determination rationale data including the determination details for the judgment rationale.

In the second judgment process, the truth/false determination module 120 may use the prosecutor-role generative AI model 132 to determine the verification-target data to be false, on the basis of the verification-target data and the judgment rationale, and output false-determination rationale data, including the determination details for the judgment rationale.

In the second judgment process, the truth/false determination module 120 may use the judge-role generative AI model 133 to determine whether the verification-target data is true or false, on the basis of the truth-determination rationale data including the determination details for the judgment rationale and the false-determination rationale data including the determination details for the judgment rationale.

For example, when the verification-target is “In World War II, the Empire of Japan conditionally surrendered after being bombed with hydrogen bombs in 1960,” the lawyer-role generative AI model 131 may assume that the corresponding content is true in the first judgment process, and the prosecutor-role generative AI model 132 may assume that the corresponding content is false to output the rationales, respectively.

In this case, the lawyer-role generative AI model 131 may output truth-determination rationale data such as “The Empire of Japan was defeated in World War II and surrendered after being bombed in Hiroshima and Nagasaki, therefore, the corresponding content is true.“ In addition, the prosecutor-role generative AI model 132 may output false-determination rationale data such as ”World War II ended in 1945, therefore, the corresponding content is false.”

In this case, the judge-role generative AI model 133 may determine that the corresponding verification-target data to be false, on the basis of the truth-determination rationale data and the false-determination rationale data, and may generate a judgment rationale such as “The Empire of Japan surrendered in 1945 after being bombed with the bombs developed by the Manhattan Project, therefore, the corresponding content is false.”

Therefore, in the second judgment process, the lawyer-role generative AI model 131 may assume that the corresponding verification-target data is true, on the basis of the determination rationale, and may output truth-determination rationale data such as “The Empire of Japan was defeated in World War II and surrendered after being bombed in Hiroshima and Nagasaki with the bombs developed by the Manhattan Project, and hydrogen bombs existed in 1960, therefore, the corresponding content is true.”

In the corresponding second judgment process, the prosecutor-role generative AI model 132 may assume that the corresponding verification-target data is false, on the basis of the determination rationale, and may output false-determination rationale data such as “The bombs developed by the Manhattan Project were atomic bombs, not hydrogen bombs, and hydrogen bombs did not exist in 1945, therefore, the corresponding content is false.”

In the corresponding second judgment process, the judge-role generative AI model 133 may generate a judgment rationale such as “The Empire of Japan surrendered in 1945 after being bombed with the atomic bombs developed by the Manhattan Project, and the surrender at that time was unconditional, not a conditional one, therefore, the corresponding content is false”, on the basis of the truth-determination rationale data including the determination details for the judgment rationale and the false-determination rationale data including the determination details for the determination rationale, and may determine that the corresponding verification-target data is false.

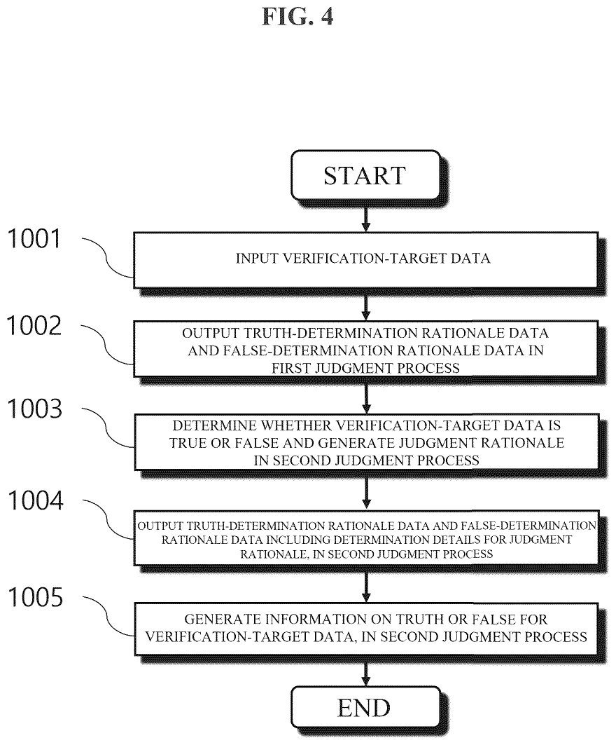

FIG. 4 is a flowchart of a method of controlling a binary reasoning prompt system according to one embodiment of the present disclosure. This is merely a preferred embodiment for achieving the objectives of the present disclosure, and certain components may be added or deleted as necessary.

Referring to FIG. 4, the input module 110 may receive verification-target data which is subject to verification to determine whether the content thereof is true or false (1001).

In the first judgment process, judgment process, the lawyer-role generative AI model 131 may determine that the input verification-target data is true and output the truth-determination rationale data for the verification-target data. In this case, the prosecutor-role generative AI model 132 may determine that the input verification-target data is false and output the false-determination rationale data for the verification-target data (1002).

In the first judgment process, the judge-role generative AI model 133 may determines whether the verification-target data is true or false, on the basis of truth-determination rationale data and the false-determination rationale data, and may generate the judgment rationale (1003).

In the second judgment process, the lawyer-role generative AI model 131 may determine that the verification-target data is true, on the basis of the verification-target data and the judgment rationale, and may output truth-determination rationale data including the determination details for the judgment rationale. In this case, the prosecutor-role generative AI model 132 may determine that the verification-target data is false, on the basis of the verification-target data and the judgment rationale, and may output false-determination rationale data including the determination details for the judgment rationale (1004).

In the second judgment process, the judge-role generative AI model 133 may determine whether the verification-target data is true or false, on the basis of the truth-determination rationale data including the determination details for the judgment rationale, and the false-determination rationale data including the determination details for the judgment rationale (1005).

To verify the performance of the binary reasoning prompt system 100, an experiment was conducted to determine whether data predetermined as true or false was indeed true or false using the Winogrande and BigBenchHard datasets. That is, a verification was conducted on accuracy in determining true verification-target data as true and false verification-target data as false.

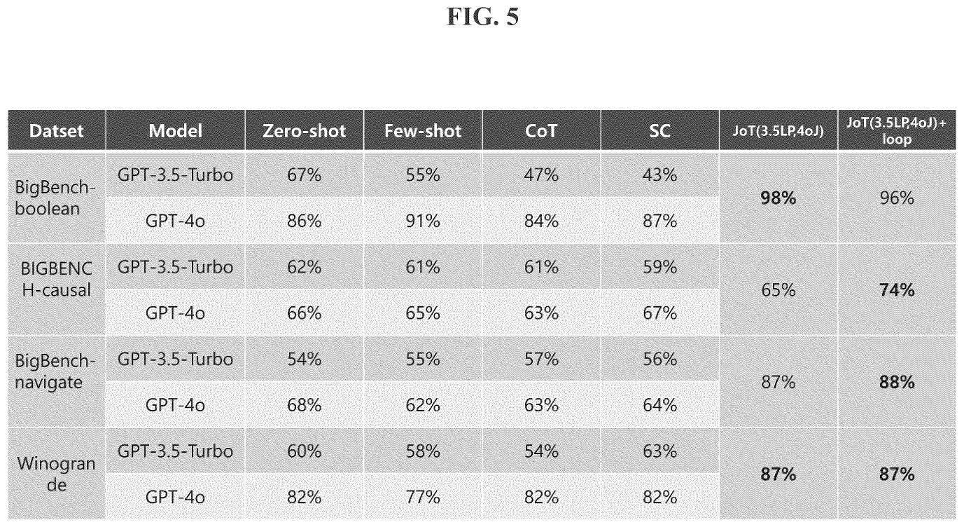

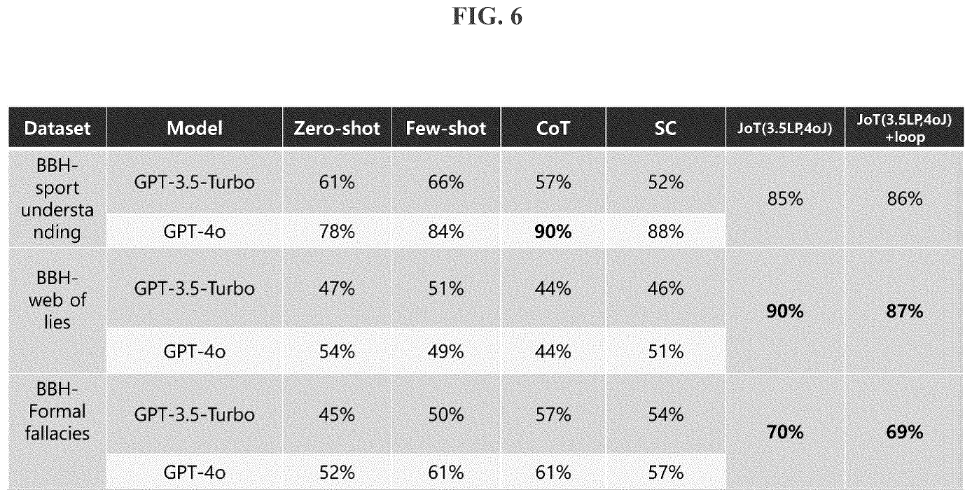

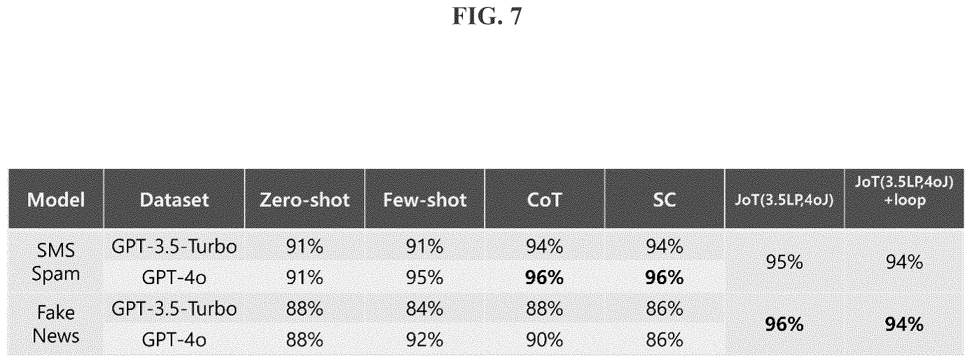

FIG. 5 is a table showing the experimental results that verifies the performance of truth/false determination of a binary reasoning prompt according to one embodiment of the present disclosure, FIG. 6 is a table showing the experimental results that verifies the performance of the binary reasoning prompt system on specific truth/false problems, and FIG. 7 is a table showing the experimental results that verifies the performance of the binary reasoning prompt system on spam SMS and fake news.

Referring to FIGS. 5, 6, and 7, it may be confirmed that a binary reasoning method (JoT) according to one embodiment of the present disclosure shows improved performance compared to other conventional reasoning methods (Zero-shot, Few-shot, Chain-of-Thought (CoT), and Self-Consistency (SC)).

In one embodiment, the binary reasoning method (JoT) demonstrated improved performance in problems such as determining whether a verification target is true or false (BigBench-boolean), determining causality (BIGBENCH-causal), determining whether movement in a coordinate plane returns to the origin (BigBench-navigate), and inferring causality (Winogrande).

In addition, the binary reasoning method (JoT) according to one embodiment also demonstrated performance in problems such as understanding of sports, for example, the verification-target data such as “In golf, par is a score higher than bogey” (BBH-sport understanding) and in reasoning problems such as “Among persons A, B, and C, only one of them lies. A tells the truth, B says A lies, and C says B is a liar. In this case, the correct answer is that B is the one who lies.” (BBH-web of lies)

Furthermore, for SMS spam and fake news datasets, the binary reasoning method (JoT) according to one embodiment was effective in detecting SMS spams (SMS Spams) and also demonstrated performance in detecting fake news as fake and real news as real (FAKE NEWS).

As described above, it may be confirmed that the binary reasoning method (JoT) demonstrates outstanding performance in structured binary logic reasoning.

The input module 110, the truth/false determination module 120, the lawyer-role generative AI model 131, the prosecutor-role generative AI model 132, and the judge-role generative AI model 133 may include any one of the plurality o processors included in the binary reasoning prompt system 100. Furthermore, the method of controlling the binary reasoning prompt system 100 according to the embodiments of the present disclosure described above and those to be described later may be implemented in the form of a program executable by the processor.

The program may include program commands, data files, and data structures, either alone or in combination. The program may be designed and constructed using machine language codes or high-level language codes. The program may be specially designed to implement the method of controlling the binary reasoning prompt system 100 described above, or may be implemented using various functions or definitions that are already known and available to those skilled in the field of computer software. The program for implementing the method of controlling the binary reasoning prompt system 100 described above may be recorded on a processor-readable recording medium. In this case, the recording medium may be the memory 130.

The memory 130 may store a program that performs the operations described above and those to be described later, and the memory 130 may execute the stored program. In cases where the processor and the memory 130 are provided in plural numbers, they may be integrated into a single chip or provided in physically separate locations. The memory 130 may include a volatile memory such as Static Random Access Memory (S-RAM) or Dynamic Random Access Memory (DRAM) for temporarily storing data. In addition, the memory 130 may include a non-volatile memory such as ROM (Read Only Memory), EPROM (Erasable Programmable Read Only Memory), and EEPROM (Electrically Erasable Programmable Read Only Memory) for storing control programs and control data for a long period of time.

The processor may include various logic circuits and arithmetic circuits, and may process data according to a program provided from the memory 130 and generate a control signal according to the processing result.

While the present disclosure has been described with reference to the illustrated embodiments, these are merely exemplary, and it will be understood by those skilled in the art that various alterations, variations, and equivalent other embodiments may be made without departing from the gist and scope of the present disclosure. Therefore, the scope of the present disclosure should be defined by the technical spirit of the appended claims.

1. A binary reasoning prompt system comprising:
an input module configured to receive verification-target data to be verified as to whether the content of data is true or false; and
a truth/false determination module configured to determine whether the verification-target data is true or false using a generative AI model on the basis of a truth determination rationale presenting the rationale for determining that the verification-target data is to be true and a false determination rationale presenting the rationale for determining that the verification-target data is to be false.

2. The binary reasoning prompt system of claim 1, wherein the generative AI model comprises:
a lawyer-role generative AI model configured to determine input verification-target data to be true and to output truth-determination rationale data for the verification-target data;
a prosecutor-role generative AI model configured to determine the input verification-target data to be false and to output false-determination rationale data for the verification-target data; and
a judge-role generative AI model configured to determine whether the verification-target data is true or false on the basis of the truth-determination rationale data and the false-determination rationale data.

3. The binary reasoning prompt system of claim 2, wherein the truth/false determination module is configured to:
input the verification-target data into the lawyer-role generative AI model and the prosecutor-role generative AI model;
input the truth-determination rationale data output by the lawyer-role generative AI model and the false-determination rationale data output by the prosecutor-role generative AI model into the judge-role generative AI model; and
determine whether the verification-target data is true or false using the judge-role generative AI model on the basis of the truth-determination rationale data and the false-determination rationale data.

4. The binary reasoning prompt system of claim 3, wherein the lawyer-role generative AI model, the prosecutor-role generative AI model, and the judge-role generative AI model are generative AI models trained by a machine learning method in which machine learning is repeatedly performed by setting learning verification-target data indicating whether each content is preset as true or false as input variables and setting information indicating whether the learning verification-target data is preset as true or false as output variables; and
the judge-role generative AI model is a generative AI model trained by the machine learning method in which repetitive machine learning is performed more times than a number of times of repetitive machine learning performed by the lawyer-role generative AI model and a number of times of repetitive machine learning performed by the prosecutor-role generative AI model.

5. The binary reasoning prompt system of claim 3, wherein the truth/false determination module is
configured to perform, a plurality of times, a judgment process in which the lawyer-role generative AI model generates the truth-determination rationale data, the prosecutor-role generative AI model generates the false-determination rationale data, and the judge-role generative AI model determines whether the verification-target data is true or false on the basis of the truth-determination rationale data and the false-determination rationale data.

6. The binary reasoning prompt system of claim 5, wherein the truth/false determination module is configured to:
determine the verification-target data to be true when the judgment processes determined as true occur more frequently among the judgment processes determined as true and the judgment processes determined as false; and
determine the verification-target data to be false when the judgment processes determined as false occur more frequently among the judgment processes determined as true and the judgment processes determined as false.

7. The binary reasoning prompt system of claim 5, wherein for each judgment process, the judge-role generative AI model is configured to:
output the truth judgment rationale presenting the rationale on which the verification-target data is determined to be true as a judgment rationale when the verification-target data is determined to be true; and
output the false judgment rationale presenting the rationale on which the verification-target data is determined to be false as the judgment rationale when the verification-target data is determined to be false.

8. The binary reasoning prompt system of claim 7, wherein the truth/false determination module is configured to:
determine whether the verification-target data is true or false using the judge-role generative AI model and generate the judgment rationale in a first judgment process which is one of a plurality of judgment processes;
input the judgment rationale output by the judge-role generative AI model into the lawyer-role generative AI model and the prosecutor-role generative AI model in a second judgment process which is a subsequent judgment process following the first judgment process;
determine the verification-target data to be true using the lawyer-role generative AI model, on the basis of the verification-target data and the judgment rationale and output truth-determination rationale data including the determination details for the judgment rationale in the second judgment process;
determine the verification-target data to be false using the prosecutor-role generative AI model, on the basis of the verification-target data and the judgment rationale and output false-determination rationale data including the determination details for the judgment rationale in the second judgment process; and
determine whether the verification-target data is true or false using the judge-role generative AI model, on the basis of the truth-determination rationale data including the determination details for the judgment rationale and the false-determination rationale data including the determination details for the judgment rationale in the second judgment process.

9. A method of controlling a binary reasoning prompt system, comprising:
receiving, by an input module, verification-target data to be verified as to whether the content of data is true or false; and
determining, by a truth/false determination module, whether the verification-target data is true or false using a generative AI model, on the basis of a truth determination rationale presenting the rationale for determining that the verification-target data is to be true and a false determination rationale presenting the rationale for determining that the verification-target data is to be false,
wherein the generative AI model includes:
a lawyer-role generative AI model configured to determine input verification-target data to be true and to output truth-determination rationale data for the verification-target data;
a prosecutor-role generative AI model configured to determine the input verification-target data to be false and to output false-determination rationale data for the verification-target data; and
a judge-role generative AI model configured to determine whether the verification-target data is true or false, on the basis of the truth-determination rationale data and the false-determination rationale data,
wherein the determining whether the verification-target data is true or false includes:
inputting, by the truth/false determination module, the verification-target data into the lawyer-role generative AI model and the prosecutor-role generative AI model;
inputting, by the truth/false determination module, the truth-determination rationale data output by the lawyer-role generative AI model and the false-determination rationale data output by the prosecutor-role generative AI model into the judge-role generative AI model; and
determining, by the truth/false determination module, whether the verification-target data is true or false using the judge-role generative AI model, on the basis of the truth-determination rationale data and the false-determination rationale data.

10. A computer program stored on a, non-transitory computer-readable recording medium to execute the method of controlling the binary reasoning prompt system according to claim 9.
